(19) United States
(12) Patent Application Publication
(10) Pub. No.: US 2016/0185469 A1
(43) Pub. Date: Jun. 30, 2016

(54) METHOD AND SYSTEM FOR AIRCRAFT APPEARANCE INSPECTION

(71) Applicant: MITSUBISHI AIRCRAFT CORPORATION, Aichi (JP)

(72) Inventors: Tomohiro UJITA, Tokyo (JP); Masayoshi SUHARA, Tokyo (JP)

(21) Appl. No.: 14/950,655

(22) Filed: Nov. 24, 2015

(30) Foreign Application Priority Data
Dec. 12, 2014 (JP) 2014-251367

(51) Int. Cl. B64F 5/00; G01N 21/88

(52) U.S. Cl. CPC B64F 5/0045; G01N 21/8851; G01N 21/8806; G01N 2021/8887

(57) ABSTRACT

An aircraft appearance inspection method includes an initial data acquisition step of acquiring initial data at an initial time, an inspection data acquisition step of acquiring inspection data at the time of inspection, and a difference acquisition step of acquiring differences between the initial data and the inspection data. A first step through a third step are performed at the initial time and at the time of inspection. The first step is to radiate light toward an applicable area of an airframe of an aircraft through a member having a repetitive pattern, in which a predetermined shape is repeated, to display on the airframe a repetitive pattern corresponding to the repetitive pattern of the member. The second step is to image the applicable area over which the repetitive pattern is displayed. The third step is to acquire data of an image taken of the applicable area.

### BACKGROUND OF THE INVENTION

1. Field of the Invention

The present invention relates to a method and a system for aircraft appearance inspection.

2. Description of the Related Art

Appearance inspection methods for the airframe of an aircraft are represented by visual inspection.

With the primary objective of speeding up inspection, a method has been proposed in which a large number of optical fiber sensors are installed in matrix on the airframe of an aircraft, and an amount of light transmitted, which varies according to stress acting on the optical fiber sensors upon application of an external force, is acquired from each optical fiber sensor to perform a computation process (Japanese Patent No. 2981562).

It is desirable that even small damage present in the airframe of an aircraft be detected accurately.

However, it takes a long time to perform visual inspection sufficiently so as to detect even small damage.

According to the method described in Japanese Patent No. 2981562, although damage can be quickly detected by performing the computation process on information acquired from the optical fiber sensors, the weight of the optical fibers installed on the airframe adds to the weight of the airframe. In the first place, it is difficult with a commercial aircraft to install a large number of optical fiber sensors on the airframe.

Japanese Patent No. 2981562 also describes ultrasonic inspection, magnetic particle inspection, eddy-current inspection, X-ray inspection, etc. as damage detection methods. However, these methods are used mainly for detecting damage present in the interior of a structure, and are not suitable for inspecting the appearance of a large-size structure, such as an aircraft, over a wide area.

The present invention therefore aims to perform aircraft appearance inspection accurately and quickly.

### SUMMARY OF THE INVENTION

An aircraft appearance inspection method of the present invention includes:

an initial data acquisition step of acquiring initial data, which is image data, by performing the following steps in a first period during which an applicable area of an airframe of an aircraft is in an initial state:

a first step of radiating light toward the applicable area through a member having a repetitive pattern, in which a predetermined shape is repeated, to display on the airframe a repetitive pattern corresponding to the repetitive pattern of the member;

a second step of imaging the applicable area over which the repetitive pattern is displayed; and

a third step of acquiring data of an image taken of the applicable area;

an inspection data acquisition step of acquiring inspection data, which is image data, by performing the first step, the second step, and the third step in a second period following the first period; and

a difference acquisition step of acquiring differences between the initial data and the inspection data.

If damage is present in the airframe, the unevenness of the damage is reflected on the repetitive pattern displayed on the airframe. Thus, even small damage can be detected easily and quickly by capturing changes in the repetitive pattern.

The airframe structure of an aircraft which is repeatedly subjected to aerodynamic loads is designed by the technique of damage-tolerant design.

Damage-tolerant design assumes that small defects/damage (initial damage) occurs during manufacturing or operation, and that from the initial damage cracks occur and grow during operation. The aim of damage-tolerant design is to maintain the soundness of the structure by ensuring, in the light of the operation period and aerodynamic loads, (1) that the crack growth rate is sufficiently low, and (2) that the limit crack dimension is large enough so that damage is reliably detected by periodical inspection before the crack grows to the limit crack dimension.

Whether or not damage can be detected at inspection is an important factor in damage-tolerant design. While smaller damage is more difficult to detect, the present invention allows detection of even smaller damage. The lower limit of the detectable size of damage is relevant to the strength/rigidity of the airframe. Since the airframe structure is designed for such strength/rigidity that can sufficiently bear the required load even if damage of the lower limit size that can be detect is present, weight reduction of the aircraft can be achieved by the present invention.

An aircraft appearance inspection system of the present invention includes: a repetitive pattern irradiation device which radiates light toward an applicable area of an airframe of an aircraft through a member having a repetitive pattern, in which a predetermined shape is repeated, to display on the airframe a repetitive pattern corresponding to the repetitive pattern of the member; an imaging device which images the applicable area over which the repetitive pattern is displayed; and an image processing device which acquires data of an image taken of the applicable area.

In the present invention, the image processing device acquires differences between the image data acquired in a first period during which the applicable area is in an initial state, and the image data acquired in a second period following the first period.

According to the present invention, it is possible to perform aircraft appearance inspection accurately and quickly.

### BRIEF DESCRIPTION OF THE DRAWINGS

FIG. 1 is a view showing a vertical tail, which is an object under inspection in an embodiment of the present invention, a pattern irradiation device, and a camera;

FIG. 2 is a view showing interlayer delamination of a member formed of a fiber-reinforced resin;

FIGS. 3A and 3B are views each showing a state of a stripe pattern when no damage is present;

FIGS. 4A and 4B are views each showing a state of the stripe pattern when damage is present;

FIG. 5 is a block diagram showing an internal configuration of an image processing device;

FIG. 6 is a view showing the procedure of appearance inspection;

FIG. 7 is a view showing one example of data of differences between initial data and inspection data;

FIG. 8A is a view showing the stripe pattern being shifted parallel to a pattern, and FIG. 8B is a view showing the stripe pattern being turned; and

FIGS. 9A and 9B are views showing another example of a repetitive pattern.

### DETAILED DESCRIPTION OF THE PREFERRED EMBODIMENTS

In the following, an embodiment of the present invention will be described with reference to the accompanying drawings.

In this embodiment, the airframe of an aircraft is inspected. The airframe of an aircraft can be damaged by a lightning strike, a bird strike, etc. The airframe is inspected to detect damage and perform necessary repairs.

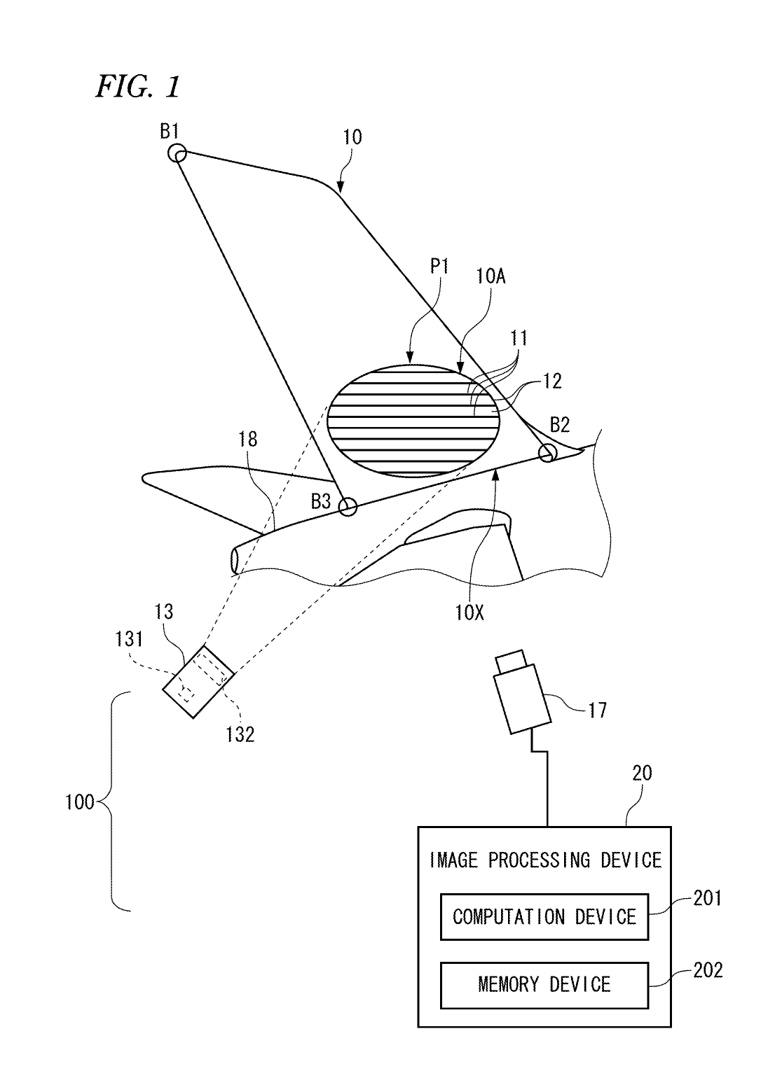

FIG. 1 shows a vertical tail 10 as a part of the airframe. In this embodiment, the vertical tail 10 is taken as an example to describe appearance inspection of the airframe of an aircraft.

The airframe of an aircraft includes skins, frames, stringers, etc. as members forming the primary structure. These members are formed of a metal material, such as an aluminum alloy, or a fiber-reinforced resin containing reinforcing fibers, such as carbon fibers or glass fibers. Members formed of a fiber-reinforced resin are composed of a plurality of layers laminated.

Damage is present in the airframe to varying degrees. Some damage is large enough to be detected at a glance, while other damage is too small to be readily detected.

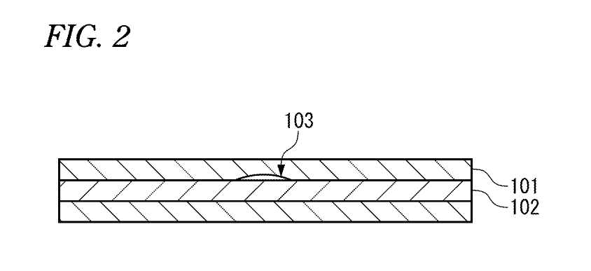

Especially in the case of members formed of a fiber-reinforced resin, unlike with members formed of a metal material, damage rarely appears in the surface of the member when the member is subjected to impact, and delamination 103 often occurs between a layer 101 and a layer 102 (interlayer delamination) as shown in FIG. 2, which makes it difficult to detect damage by appearance inspection.

Aircraft appearance inspection is represented by visual inspection.

While visual inspection is relatively easy to perform, it is necessary to take time and thoroughly observe the surface of an airframe if even small damage is to be detected, and the size of damage that can be detected with the resolution power of the naked eye is limited. Moreover, detection accuracy varies according to the level of skill of a maintenance worker in charge of inspection. The lower limit of the detectable size of damage is said to be approximately 0.3 mm, for example, even when a skilled maintenance worker observes the surface of an airframe from a short distance. That is, damage of 0.2 mm present in the surface of an airframe, if any, cannot be recognized simply by sighting.

Here, the weight of an airframe is affected by how small the detectable size of damage is.

If damage larger than 0.3 mm is detectable but damage not larger than 0.3 mm is undetectable, the airframe structure is designed for such strength/rigidity that can sufficiently bear the required load even if damage of 0.3 mm is present. This results in an increase in weight of the airframe compared with a case where the criterial size of detectable/undetectable damage is smaller (e.g., 0.1 mm).

This embodiment visualizes damage so that small damage can be detected. For this purpose, a stripe pattern P1 is displayed on the surface of the airframe (here, on the surface of the vertical tail 10) as schematically shown in FIG. 1.

The stripe pattern P1 includes a plurality of lines 11 which are arrayed periodically at regular intervals (with a space 12 in between). The stripe pattern P1 corresponds to a repetitive pattern in which a predetermined shape (in this case, the line 11) is repeated periodically. The interval between the lines 11 is actually much narrower.

This stripe pattern P1 is projected on the surface of the airframe by a pattern irradiation device 13.

The pattern irradiation device 13 includes a light source 131 and a repetitive pattern member 132 having a plurality of slits, through which light emitted from the light source is transmitted, formed at a predetermined pitch.

A laser light source can be preferably used as the light source 131 in order to obtain the clear stripe pattern P1 without blurring of the lines 11 and with high contrast between the lines 11 and the spaces 12. Other than a laser light source, a polarized light source can also be used.

As an irradiation area 10A of the vertical tail 10 is irradiated with light emitted from the light source 131 through the repetitive pattern member 132, the stripe pattern P1 is displayed over the entire, or almost the entire, irradiation area 10A.

The light source 131 and the repetitive pattern member 132 can also be configured as separate devices.

Visualization of damage by means of the stripe pattern P1 displayed on the surface of the airframe will be described below.

The lines 11 and the spaces 12 of the stripe pattern P1 assume a shape according to the shape of the surface of the airframe in the irradiation area 10A. If no damage is present in the area irradiated with light, the lines 11 and the spaces 12 of the stripe pattern P1 are arrayed with regularity.

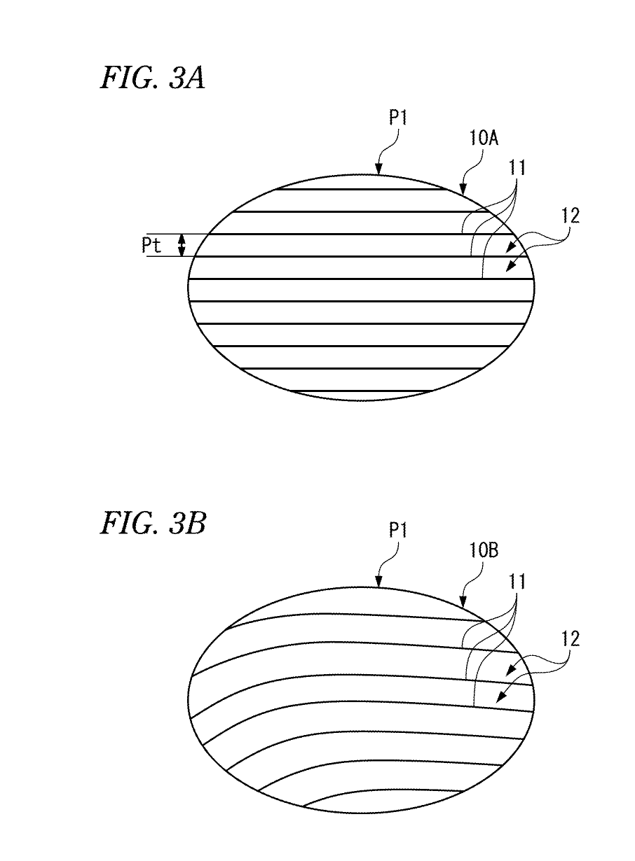

FIG. 3A shows the stripe pattern P1 displayed over the irradiation area 10A which is a flat surface. The lines 11 of the stripe pattern P1 are parallel to one another and extend linearly while keeping a certain pitch Pt.

FIG. 3B shows an example of the stripe pattern P1 displayed over an irradiation area 10B which is a gradually curved surface of the airframe. The lines 11 of the stripe pattern P1 are also curved gradually so as to follow the curved shape of the surface of the airframe.

When a rising portion 10X of the vertical tail 10 rising from a tail cone 18 (FIG. 1) is included in the irradiation area, the lines 11 displayed on and around the rising portion 10X are curved so as to follow the shape of the surface of the airframe. Thus, the lines 11 are displayed in the form of contour lines on and around the rising portion 10X.

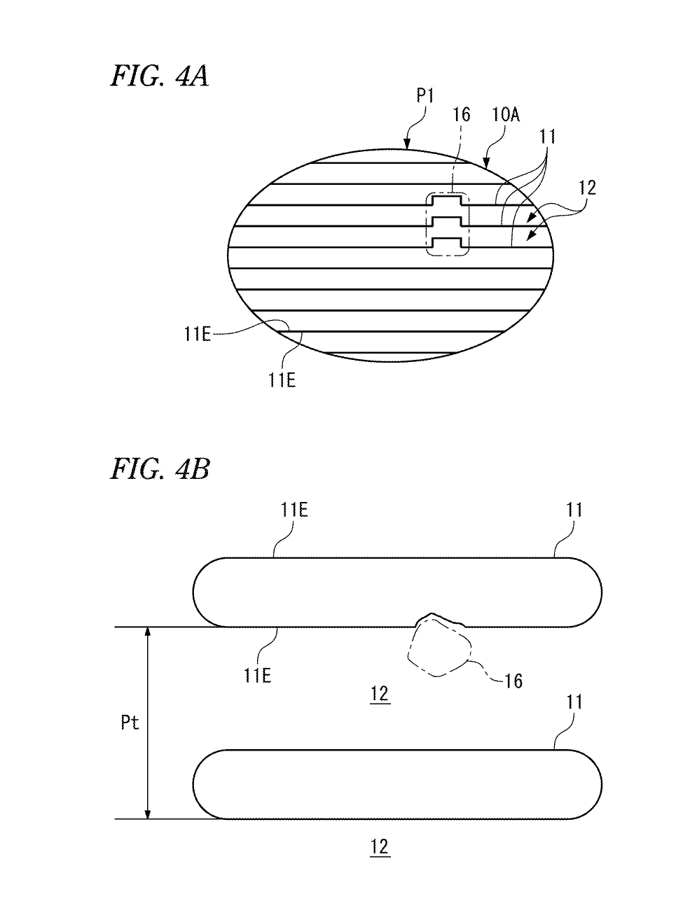

On the other hand, if damage is present in the surface of the airframe, for example, as shown in FIG. 4A, the regularity of the shape of the stripe pattern P1 is partially lost. FIG. 4A corresponds to the irradiation area 10A shown in FIG. 3A.

Damage 16 is present in the irradiation area 10A shown in FIG. 4A. The damage 16 is a depression (dent) due to an impact load, or is a bump, a crack, etc. around the depression, and has an uneven surface.

If the stripe pattern P1 is not displayed, it is difficult to visually recognize the small damage 16, which can be present somewhere in the surface of the airframe, on the basis of the difference in reflection intensity etc. between the small damage 16 and the surrounding area.

The stripe pattern P1 helps visually recognize such small damage 16.

Since there is a large difference in light reflection intensity between the lines 11 and the spaces 12 based on the contrast between the lines 11 and the spaces 12, the lines 11 are highly visible in the irradiation area 10A. More particularly, since there is a large difference in light reflection intensity between the inside (on the lines 11) and the outside (in the spaces 12) of edges 11E (FIG. 4B), the edges 11E of the lines 11 are highly visible compared with other areas.

Therefore, it is easy to visually recognize that the single or plurality of lines 11 traversing the damage 16 are distorted or discontinuous as shown in FIG. 4A so as to reflect the uneven shape of the damage 16.

Depending on the relation between the size of the damage 16 and the pitch Pt of the lines 11, the edge 11E is chipped at the position of the damage 16 as shown in FIG. 4B. Such chipping is also easy to visually recognize.

If the lines 11 reflect the shape of the damage 16 as shown in FIGS. 4A and 4B, the regularity of the shape of the stripe pattern P1 is disturbed. This disturbance in regularity is easy to visually recognize.

The damage 16 is visualized as the uneven shape of the damage 16 is thus reflected on the lines 11 of the stripe pattern P1.

With the damage 16 thus visualized, even an unskilled person can easily and quickly detect the small damage 16 which cannot be detected simply by sighting, or which is difficult to detect unless sighted with utmost care.

Since the small damage 16 can be detected, the lower limit of the detectable size of the damage 16 can be lowered than ever. The lower limit value is determined by the pitch Pt of the lines 11 of the stripe pattern P1. It is therefore possible to define the lower limit of the detectable size of the damage 16 at a desired value by appropriately setting the pitch of the slits of the repetitive pattern member 132 forming the stripe pattern P1.

For example, the pitch Pt of the lines 11 of the stripe pattern P1 can be set to 0.1 mm to 3 mm.

If the lower limit of the detectable size of the damage 16 is lowered and such small damage 16 becomes detectable, weight reduction of the airframe structure can be achieved, since the required strength/rigidity is reduced compared with the case where the airframe structure is designed on the assumption that the damage 16 of a certain size, which is undetectable, is present from the beginning.

As shown in FIG. 2, even damage (not shown), which may slightly appear in the surface of a member when the member is subjected to an external force causing the interlayer delamination 103, can be detected if the shape of the damage is reflected on the lines 11 of the stripe pattern P1.

Thus, visualization of the damage 16 through display of the stripe pattern P1 has great significance especially in inspection of fiber-reinforced resin members on which appearance inspection is difficult to perform.

On the basis of the basic concept of detection of the small damage 16 having been described so far, a system will be described below which performs aircraft appearance inspection by performing image processing on data of images taken with a camera.

Such an appearance inspection system 100 (FIG. 1) includes the above-described repetitive pattern irradiation device 13, a camera 17 which images the irradiation area 10A over which the stripe pattern P1 is displayed by the repetitive pattern irradiation device 13, and an image processing device 20 which acquires data of images taken of the irradiation area 10A.

The appearance inspection system 100 acquires data of images of the irradiation area 10A taken by the camera 17, which substitutes for sighting, and performs information processing on the basis of the image data acquired.

The camera 17 is a digital camera, and sends data of images taken by a built-in imaging element to the image processing device 20. The camera 17 has sufficiently high resolution relative to the pitch Pt of the lines 11.

The image processing device 20 is a general-purpose computer, and includes a computation device 201 and a memory device 202. The image processing device 20 is connected with a monitor (not shown) and input means, such as a keyboard (not shown).

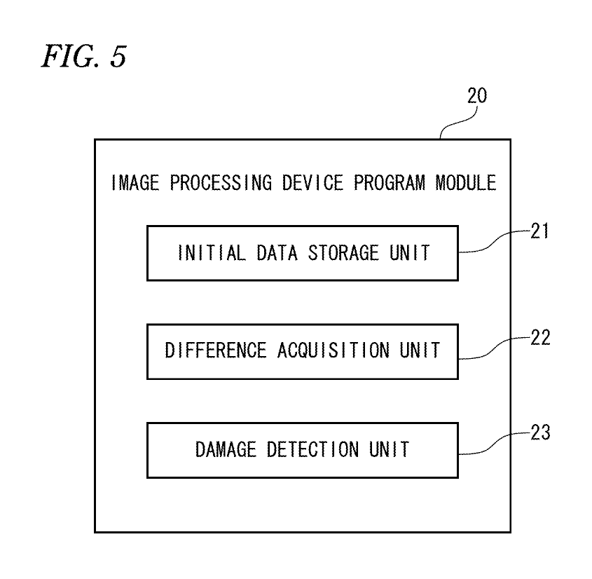

As a program module operating on a predetermined computer program, the image processing device 20 includes an initial data storage unit 21, a difference acquisition unit 22, and a damage detection unit 23, as shown in FIG. 5.

In this embodiment, the surface of the airframe on which the stripe pattern P1 is displayed is imaged at an initial time (first period), which precedes operation of the aircraft and in which no damage 16 is present, and at the time of inspection (second period). The damage 16 is detected by comparing and matching image data obtained at the time of inspection and image data obtained at the initial time.

To exactly compare the image data at the initial time (initial data) and the image data at the time of inspection (inspection data), these pieces of image data include common reference points (positions indicated by circles in FIG. 1) which are used for positioning the image data. In this embodiment, images are taken so as to include, in the view of the camera 17, a first reference point B1 located at the upper end of the vertical tail 10, a second reference point B2 located at the front end of the rising portion 10X of the vertical tail 10, and a third reference point B3 located at the rear end thereof, along with the irradiation area over which the stripe pattern P1 is displayed.

Since a plane is uniquely defined by the three reference points B1 to B3, two images can be mapped on the same coordinate using these reference points.

Alternatively, four or more reference points can be used. In that case, measurement error can be suppressed, as accidental error or the like is averaged and variation is reduced due to the large parameter.

These reference points B1 to B3 can be separately provided with an identifiable mark. Examples of the mark include a label bearing an optically readable code, such as a bar-code or a QR code (R). The label should be attached to the surface of the airframe before imaging and be detached after imaging.

Instead of providing the reference points B1 to B3 with a special mark, a characteristic part which can be distinguished from the surrounding area, such as the edge of the vertical tail 10, or a symbol or a logo depicted on the vertical tail 10, can also be used as the reference point. It is possible, without giving a mark to such a characteristic part, to detect the characteristic part by publicly-known image processing and give it a separate identification code on the image data.

A plurality of irradiation areas can be set on the surface of the vertical tail 10. Adjacent ones of the irradiation areas may partially overlap. As long as the entire surface of the vertical tail 10 (the entire surface on the right side in FIG. 1) can be included at once in the view of the camera 17, a single irradiation area can be set on the vertical tail 10.

For the fuselage, the main wing, the horizontal tail, etc. other than the vertical tail 10 as well, irradiation areas can be set as with the vertical tail 10.

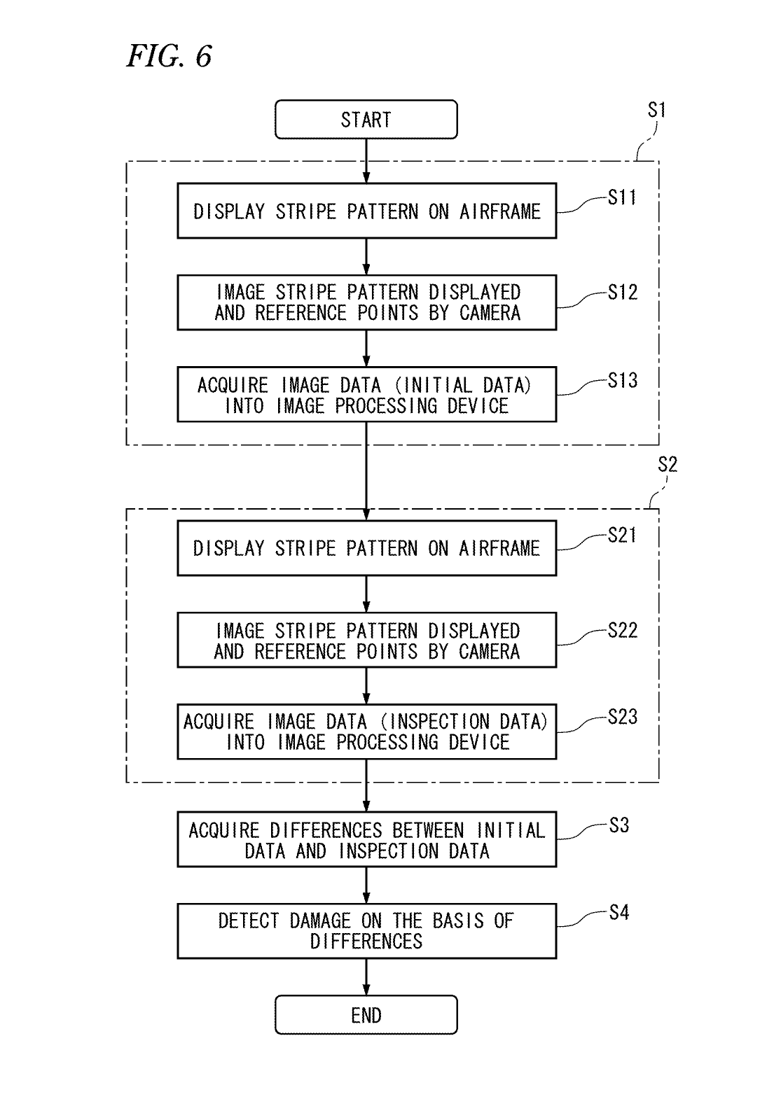

The procedure of appearance inspection of the vertical tail 10 will be described below with reference to FIG. 6. In the description, the workings of each program module (FIG. 5) of the image processing device 20 will also be described.

First, at the initial time preceding operation of the aircraft, initial data of an image taken of the surface of the airframe on which the stripe pattern P1 is displayed is acquired (initial data acquisition step S1).

In the initial data acquisition step S1, first, the stripe pattern P1 is displayed over a predetermined area under inspection (irradiation area 10A) of the vertical tail 10 by the repetitive pattern irradiation device 13 (step S11).

Subsequently, the area including the irradiation area 10A, over which the stripe pattern P1 is displayed, and the reference points B1 to B3 is imaged by the camera (step S12).

Further, the data of the image taken is acquired by the image processing device 20 (step S13). At this point, the image data sent from the camera 17 to the image processing device 20 is stored as initial data in the memory device 202 by the initial data storage unit 21.

The initial data storage unit 21 stores pieces of the initial data in connection with the respective irradiation areas. The pieces of the initial data corresponding to the respective irradiation areas each include the regular stripe pattern as shown in FIGS. 3A and 3B.

To clearly display the stripe pattern P1, it is preferable to take images inside a hangar which is dimly lit by reduced illumination. The same applies to imaging at the time of inspection.

Next, for appearance inspection performed periodically or as necessary on an aircraft in operation, inspection data of an image taken of the surface of the airframe, over which the same stripe pattern P1 as the stripe pattern P1 at the initial time, is acquired (inspection data acquisition step S2).

In the inspection data acquisition step S2, as in the initial data acquisition step S1, first, the stripe pattern P1 is displayed on the irradiation area 10A by the repetitive pattern irradiation device 13 (step S21).

Here, the same area as at the initial time is irradiated with light by installing the pattern irradiation device 13 at the same position as the position at the initial time and in the same direction as at the initial time relative to the object to be imaged.

Subsequently, the area including the irradiation area 10A, over which the stripe pattern P1 is displayed, and the reference points B1 to B3 is imaged by the camera (step S22).

It is preferable that the camera 17 is also installed at the same position as the position at the initial time and in the same direction as at the initial time toward the object to be imaged so as to set the focal length to the same length as at the initial time.

Even if there is a slight difference in position or direction of the camera 17, such a difference can be corrected by publicly-known image processing.

Further, the data of the image taken is acquired by the image processing device 20 (step S23). The data of the image taken (inspection data) is sent to the difference acquisition unit 22 of the image processing device 20.

Next, the difference acquisition unit 22 performs a difference acquisition step S3.

The difference acquisition unit 22 reads out the initial data from the memory device 202, and after correcting the inspection data as necessary, aligning the reference points B1 to B3 on the initial data respectively with the reference points B1 to B3 included in the inspection data to map the inspection data and the initial data on the same coordinate.

This makes it possible to compare and match the inspection data and the initial data, and the difference acquisition unit 22 acquires differences between the initial data and the inspection data by performing computation by the computation device 201. Each pixel of the image data is given a value indicating the degree of contrast (contrast value). The pixels in the image acquired by the camera 17 indicate the contrast values corresponding to the light intensity detected by the imaging element of the camera 17. It is preferable that each pixel is given a contrast value which is obtained by normalizing the contrast value of the image taken to, for example, a value ranging from “0” indicating black to “255” indicating white.

Then, the difference in contrast value between the corresponding pixels of the initial data and the inspection data is computed. A collection of the differences in contrast value constitutes the differences (difference data) between the initial data and the inspection data.

While differences may be acquired over the entire images of the initial data and the inspection data, the irradiation area may be extracted from each of the initial data and the inspection data and differences between the irradiation area of the initial data and the irradiation area of the inspection data may be found. In this way, the inspection time can be reduced.

As a result of finding differences between the initial data and the inspection data, the value “0” is obtained as the value for pixels of which the contrast has not changed from the initial time. On the other hand, a value other than “0”, specifically, a value corresponding to the amount of change in contrast value from the initial time is obtained as the value for pixels of which the value has changed from the initial time.

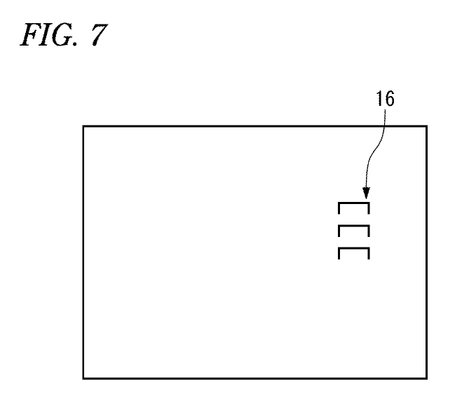

As one example of the difference data, FIG. 7 shows an image of differences between the initial data of an image taken of the irradiation area 10A shown in FIG. 3A and the inspection data of an image taken of the irradiation area 10A shown in FIG. 4A. As is clear from FIG. 7, disturbance in regularity, such as distortion or discontinuity, or chipping of the edges 11E, of the single or plurality of lines 11 traversing the damage 16, which reflects the uneven shape of the damage 16, is visualized in the image as well owing to the above-described visibility of the edges 11E of the lines 11. For example, a threshold value can be used to easily extract from the difference data only those pixels of which the amount of change in contrast value is large due to change in reflection intensity attributable to the presence of the unevenness of the damage 16. The threshold value can be set to 100, for example, and those pixels of which the amount of change in contrast value is above 100 should be extracted. The threshold value can be set to an appropriate value such that pixels showing the damage 16 are reliably extracted while extraction of noise irrelevant to the damage 16 is avoided.

Suppose that initial data and inspection data are acquired without the line 11 being projected and differences between these pieces of data are found. Then, it is difficult to set the threshold value due to the low contrast between the damage 16 and the surrounding area, so that it is difficult to distinguish between noise and the damage 16 and extract the pixels showing the damage 16. By contrast, if the lines 11 are projected, for example, the lines 11 near the damage 16 shift as shown in FIG. 4A, increasing the contrast with the surrounding area where no change is occurring, so that the threshold value can be set to a relatively large value with allowance for noise. Thus, the pixels showing the damage 16 can be extracted reliably. Setting the threshold value can eliminate differences between imaging conditions (exposure, white balance, etc.) at the initial time and those at the time of inspection.

It is possible to detect the presence/absence of the damage 16, the size of the damage 16, the position of the damage 16, etc. by extracting pixels on the basis of the amount of change in contrast value indicated by the difference data.

By checking the positions of pixels, the contrast values of the pixels, the number of pixels continuous or forming a group, etc. extracted from the difference data against predetermined standards, only those pixels that meet the standards can be detected as the damage 16.

Instead of directly acquiring differences between the initial data and the inspection data as has been described above (including the case where the difference in value obtained by normalizing the initial data and the inspection data is acquired), the contrast values of the initial data and the inspection data may be monochromatized (binarized) into two colors in advance on the basis of certain standards, and differences between the initial data and the inspection data, both in monochrome, may be acquired.

Then, the differences are also binarized into “±1” indicating the presence of a difference and “0” indicating the absence of a difference. Thus, the presence/absence of a change becomes apparent and the damage 16 can be detected.

The approach of monochromatizing the initial data and the inspection data in advance is suitable where the threshold value for differences acquired is difficult to set, for example, due to the low contrast between the lines 11 and the color of the airframe.

While the above-described detection of the damage 16 can also be performed manually on the basis of the difference data output by the difference acquisition unit 22, in this embodiment, this detection is performed by the damage detection unit 23 of the image processing device 20.

The damage detection unit 23 detects the presence/absence of the damage 16, the size of the damage 16, the position of the damage 16, etc. on the basis of the data extracted from the difference data (step S4).

To eliminate noise and increase the detection accuracy, performing a predetermined image filtering process etc. on the difference data is also effective.

The appearance inspection is completed by performing the inspection data acquisition step S2 and the difference acquisition step S3 described above over the required area of the airframe.

Thereafter, the position, the size, etc. of the damage 16 detected are evaluated, and if the damage 16 requires maintenance, such as repairs or replacement of the member, the appearance inspection is followed by work for repairs, replacement of the member, etc.

According to this embodiment, by performing image processing on the data of images taken by the camera 17 of the surface of the airframe on which the stripe pattern P1 is displayed, it is possible to detect the damage 16 accurately and quickly, in an easy manner without employing any special device, and with more uniform inspection quality than is possible by sighting with the stripe pattern P1.

This embodiment can finish inspection in a short time and put an aircraft back into operation.

This embodiment can achieve weight reduction of an aircraft by allowing detection of even the small damage 16 and lowering the lower limit of the detectable size of damage.

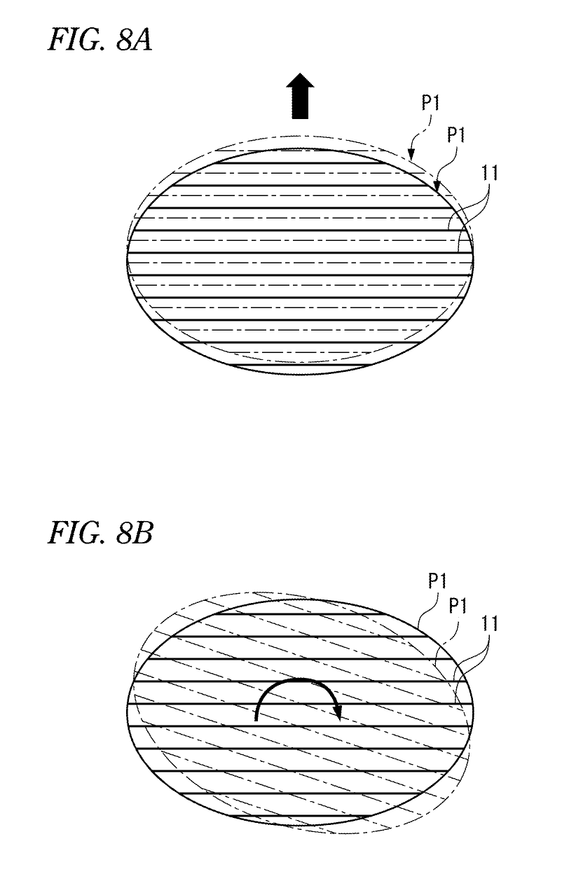

To further enhance the detection accuracy in this embodiment, the surface of the airframe should be observed while the position irradiated with the stripe pattern P1 is shifted gradually in the array direction of the lines 11 as indicated by the arrow in FIG. 8A, or while the stripe pattern P1 is turned around the center of the plane as shown in FIG. 8B.

To do this, the repetitive pattern member 132 should be shifted or turned. Thus, the damage 16 can be captured which has been shifted onto the single or plurality of lines 11 as the repetitive pattern member 132 has been shifted or turned.

Otherwise, the configurations introduced in the above embodiment can be selectively adopted or be modified as appropriate into other configurations within the scope of the present invention.

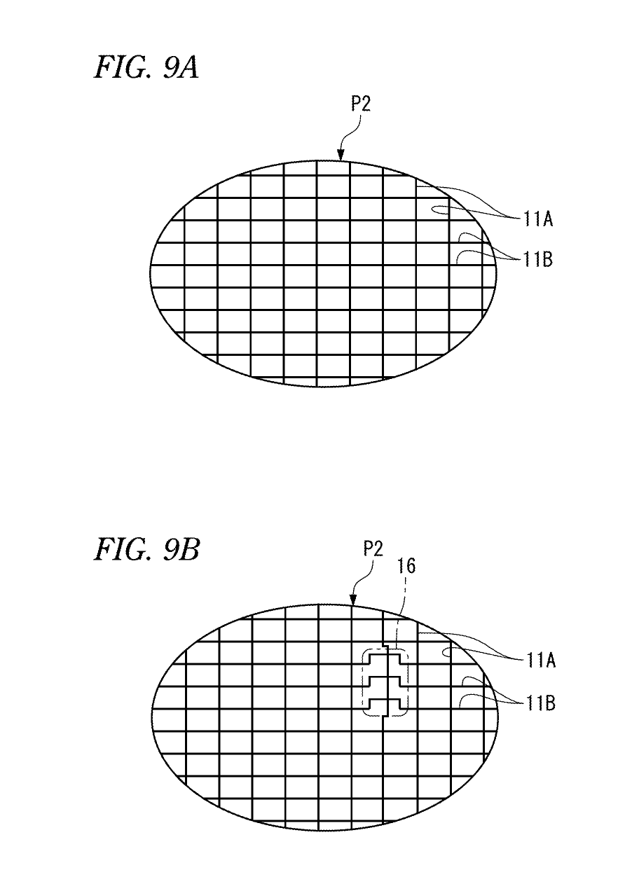

In the above embodiment, a two-dimensional array pattern P2 shown in FIG. 9A can also be used instead of the stripe pattern P1. The two-dimensional array pattern P2 is formed of a plurality of lines 11A arrayed in parallel to one another and a plurality of lines 11B intersecting the lines 11A.

The damage 16 can be detected accurately on the basis of distortion etc. of the lines 11A, 11B as shown in FIG. 9B by means of the two-dimensional array pattern P2 as well.

Using the two-dimensional array pattern P2 can produce the same effects as when an object is imaged at 0° and 90° using the stripe pattern P1.

The present invention also encompasses the case where a pattern irradiation device having a stripe pattern formed of the lines 11A and another pattern irradiation device having a stripe pattern formed of the lines 11B are used to display the two-dimensional array pattern P2 on the airframe by laying the irradiation patterns of these irradiation devices on top of each other over the same area.

What is claimed is:

1. An aircraft appearance inspection method comprising:
an initial data acquisition step of acquiring initial data, which is image data, by performing the following steps in a first period during which an applicable area of an airframe of an aircraft is in an initial state:
a first step of radiating light toward the applicable area through a member having a repetitive pattern, in which a predetermined shape is repeated, to display on the airframe a repetitive pattern corresponding to the repetitive pattern of the member;
a second step of imaging the applicable area over which the repetitive pattern is displayed; and
a third step of acquiring data of an image taken of the applicable area;
an inspection data acquisition step of acquiring inspection data, which is image data, by performing the first step, the second step, and the third step in a second period following the first period; and
a difference acquisition step of acquiring differences between the initial data and the inspection data.

2. The method according to claim 1, wherein the repetitive pattern displayed on the airframe is a stripe pattern including a plurality of lines arrayed periodically at predetermined intervals.

3. The method according to claim 1, wherein a regularity of a shape of the repetitive pattern displayed on the airframe is partially lost when damage is present in the applicable area.

4. The method according to claim 1, wherein, in the second step, an area including the applicable area over which the repetitive pattern is displayed and a plurality of reference points is imaged.

5. The method according to claim 1, wherein, in the difference acquisition step, a difference in contrast value between corresponding pixels of the initial data and the inspection data is computed.

6. An aircraft appearance inspection system used in the method according to claim 1, the system comprising:
a repetitive pattern irradiation device which displays on the airframe the repetitive pattern corresponding to the repetitive pattern of the member;
an imaging device which images the applicable area over which the repetitive pattern is displayed; and
an image processing device which acquires data of the image taken of the applicable area, wherein
the image processing device acquires differences between the image data acquired in the first period and the image data acquired in the second period.

7. An aircraft appearance inspection system comprising:
a repetitive pattern irradiation device which radiates light toward an applicable area of an airframe of an aircraft through a member having a repetitive pattern, in which a predetermined shape is repeated, to display on the airframe a repetitive pattern corresponding to the repetitive pattern of the member;
an imaging device which images the applicable area over which the repetitive pattern is displayed; and
an image processing device which acquires data of an image taken of the applicable area, wherein
the image processing device acquires differences between the image data acquired in a first period during which the applicable area is in an initial state, and the image data acquired in a second period following the first period.

8. The system according to claim 7, wherein the member includes a plurality of slits, through which light is transmitted, formed at a predetermined pitch.

9. The system according to claim 7, wherein a regularity of a shape of the repetitive pattern displayed on the airframe is partially lost when damage is present in the applicable area.

10. The system according to claim 7, wherein the image data acquired in the first period and the image data acquired in the second period each include common reference points.

11. The system according to claim 7, wherein the image processing device computes a difference in contrast value between corresponding pixels of the image data acquired in the first period and the image data acquired in the second period.
